(19) United States
(12) Patent Application Publication
(10) Pub. No.: US 2025/0056346 A1
(43) Pub. Date: Feb. 13, 2025

(54) PARTIAL RRC DECODING

(71) Applicant: Nokia Technologies Oy, Espoo (FI)

(72) Inventors: Endrit DOSTI, Espoo (FI); Tero Henttonen, Espoo (FI)

(21) Appl. No.: 18/758,521

(22) Filed: Jun. 28, 2024

(30) Foreign Application Priority Data
Aug. 10, 2023 (GB) 2312258.3

(51) Int. Cl. H04W 36/00; H04W 36/08

(52) U.S. Cl. CPC H04W 36/0083; H04W 36/08

(57) ABSTRACT

A user equipment comprising means for:
decoding and applying a received cell-change measurement configuration before decoding a received cell-change configuration,
wherein the cell-change measurement configuration provides measurement parameters specifying
measurements to be performed for managing a handover, and
wherein the cell-change configuration provides cell parameters enabling the handover.

### TECHNOLOGICAL FIELD

Examples of the disclosure relate to handover. Some relate to lower-latency handover, for example lower layer triggered handover.

### BACKGROUND

Handover transfers an ongoing communication session of a user equipment (UE) from one cell to another cell in connected state. Handover is used to provide continuity of service for the user, especially while the user is on the move.

Historically cell level mobility has been configured at layer-3 (e.g., radio resource control RRC). The network controls UE mobility based on UE measurement reporting. The trigger for completing handover can be the network, or with conditional handover, the user equipment. Conditional handover is executed by the user equipment only when a network configured execution condition is met. The decision to trigger or configure handover is made on layer 3 measurements.

Dual Active Protocol Stack (DAPS) handover allows a user equipment to initiate a handover to a target cell while maintaining the connection with the source cell by activating two protocol stacks, one for the source cell and the other for the target cell.

Lower layer triggered mobility (LTM) enables handover via L1/L2 signaling, while keeping configuration of the upper layers and/or minimizing changes of configuration of the lower layers. The network triggers a LTM cell switch by sending a MAC control element (CE) to the UE. As currently proposed, a MAC CE indicates a cell-change configuration that the network previously prepared and provided to the UE through layer-3 (RRC) signaling. A cell-change configuration can only be added, modified, and released by network via RRC signaling. In some examples, the network receives L1/L2 measurement reports from UEs, and in response changes a UE's serving cell by a cell switch command through a MAC CE.

LTM supports both intra-distributed unit (DU) and intra-central unit (CU)-inter-DU mobility. As proposed, the trigger for the LTM handover process is in a DU, and the DU sends the MAC CE for LTM handover, however, the entire setup for LTM cell switch is performed via the CU and transmitted to the UE via an RRC Reconfiguration message. The transmitted RRC Reconfiguration message contains both measurement configurations and cell-change configurations for all the cells that have been configured with LTM. The RRC Reconfiguration message is decoded at the UE.

### BRIEF SUMMARY

According to various, but not necessarily all, examples there is provided a user equipment comprising means for:

decoding and applying a received cell-change measurement configuration before decoding a received cell-change configuration,
wherein the cell-change measurement configuration provides measurement parameters specifying measurements to be performed for managing a handover, and
wherein the cell-change configuration provides cell parameters enabling the handover.

In some but not necessarily all examples, the user equipment comprises means for: decoding the received cell-change measurement configuration; performing the measurements in accordance with the received cell-change measurement configuration; and in dependence upon the measurements, decoding the received cell-change configuration.

In some but not necessarily all examples, the user equipment comprises means for: determining to initiate the handover with a candidate cell; and decoding the received cell-change configuration for the candidate cell based on the determination.

In some but not necessarily all examples, the user equipment comprises means for transmitting to the network a lower layer triggered mobility (LTM) measurement report in dependence upon the performed measurements.

In some but not necessarily all examples, the user equipment comprises means for: confirming to the network a decoding of the received cell-change measurement configuration and/or confirming to the network a decoding of the received cell-change configuration.

In some but not necessarily all examples, the user equipment comprises means for: receiving from a network a first message comprising the cell-change measurement configuration and a second message comprising the cell-change configuration.

In some but not necessarily all examples, the user equipment comprises means for decoding the received cell-change measurement configuration; performing the measurements in accordance with the cell-change measurement configuration; in dependence upon the measurements, sending a measurement report to the network; and decoding the cell-change configuration.

In some but not necessarily all examples, the measurement report is a lower layer triggered mobility (LTM) measurement report.

In some but not necessarily all examples, the measurement report identifies one or more cells and the second message comprises the cell-change configuration for each of the identified one or more cells.

In some but not necessarily all examples, the user equipment comprises means for decoding the first message on reception and/or decoding the second message on reception.

In some but not necessarily all examples, the user equipment comprises means for receiving from a network a message comprising the cell-change measurement configuration and the cell-change configuration.

In some but not necessarily all examples, the message comprises layer-3 radio Resource Control (RRC) information.

In some but not necessarily all examples, the user equipment comprises means for using the measurements made according to the cell-change measurement configuration for a UE triggered change of cell.

In some but not necessarily all examples, the message comprises:

a data structure comprising a first information element comprising the cell-change measurement configuration wherein the cell-change measurement configuration provides parameters specifying the measurements to be performed for managing the handover; and multiple second information elements, wherein each of the multiple second information elements comprises the cell-change configuration for one of multiple candidate cells, and wherein the cell-change configuration provides parameters enabling the handover with one of the multiple candidate cells.

According to various, but not necessarily all, examples there is provided a method comprising: decoding and applying a received cell-change measurement configuration before decoding a received cell-change configuration,

wherein the cell-change measurement configuration provides measurement parameters specifying measurements to be performed for managing a handover, and
wherein the cell-change configuration provides cell parameters enabling the handover.

According to various, but not necessarily all, examples there is provided a computer program than when executed by one or more processors causes: decoding and applying a received cell-change measurement configuration before decoding a received cell-change configuration, wherein the cell-change measurement configuration provides measurement parameters specifying measurements to be performed for managing a handover, and wherein the cell-change configuration provides cell parameters enabling the handover.

According to various, but not necessarily all, examples there is provided a network node comprising means for: sending to a user-equipment a cell-change measurement configuration wherein the cell-change measurement configuration provides measurement parameters specifying measurements to be performed for managing a handover; and sending, separately, to the user equipment a cell-change configuration, wherein the cell-change configuration provides cell parameters enabling the handover.

In some but not necessarily all examples, the network node is configured to send a first message comprising the cell-change measurement configuration and, separately, a second message comprising the cell-change configuration.

In some but not necessarily all examples, the network node is configured to, in response to receiving from the user equipment a measurement report for managing handover that identifies a cell, selectively sending to the user equipment a cell-change configuration for enabling cell change to the identified cell or configured to, in response to receiving from the user equipment a measurement report for managing handover that identifies a sub-set of cells, selectively sending to the user equipment a cell-change configuration for enabling cell change to each of the identified sub-set of cells.

In some but not necessarily all examples, the network node is configured to receive a message comprising the cell-change measurement configuration and a cell-change configuration for multiple cells; and is configured to send the received cell-change measurement configuration, but not a received cell-change configuration to the user equipment; and is configured to selectively send to the user equipment a cell-change configuration for enabling cell change to a sub-set of cells.

In some but not necessarily all examples, the network node is configured to, in response to receiving from the user equipment a measurement report for managing handover that identifies a sub-set of the multiple cells, selectively send to the user equipment a cell-change configuration for enabling cell change to each of the identified sub-set of cells.

In some but not necessarily all examples, the received message comprises a data structure comprising: a first information element comprising the cell-change measurement configuration wherein the cell-change measurement configuration provides parameters specifying the measurements to be performed for managing the handover; and multiple second information elements, wherein each of the multiple second information elements comprises the cell-change configuration for one of multiple candidate cells, and wherein the cell-change configuration provides parameters enabling the handover with one of the multiple candidate cells.

In some but not necessarily all examples, the received message comprises mapping information that comprises one-to-one mappings for each cell-change measurement configuration, that map the cell-change measurement configuration to a cell identifier, thereby obviating the need to decode the cell-change measurement configuration.

In some but not necessarily all examples, the network node is configured as a distributed unit.

According to various, but not necessarily all, examples there is provided a method comprising:

sending to a user-equipment a cell-change measurement configuration wherein the cell-change measurement configuration provides measurement parameters specifying measurements to be performed for managing a handover; and
sending, separately, to the user equipment a cell-change configuration, wherein the cell-change configuration provides cell parameters enabling the handover.

According to various, but not necessarily all, examples there is provided a computer program than when executed by one or more processors of a network causes: sending to a user-equipment a cell-change measurement configuration wherein the cell-change measurement configuration provides measurement parameters specifying measurements to be performed for managing a handover; and sending, separately, to the user equipment a cell-change configuration, wherein the cell-change configuration provides cell parameters enabling the handover.

According to various, but not necessarily all, examples there is provided examples as claimed in the appended claims.

According to various, but not necessarily all, examples there is provided a user equipment comprising means for:

decoding and using a received cell-change measurement configuration before decoding a received cell-change configuration,
wherein the cell-change measurement configuration provides measurement parameters specifying
measurements to be performed for the purpose of managing a change in a serving cell and
wherein the cell-change configuration provides cell parameters enabling a change in serving cell.

According to various, but not necessarily all, examples there is provided a user equipment comprising means for:

receiving from a network a first message comprising a cell-change measurement configuration,
decoding the received cell-change measurement configuration, wherein the cell-change measurement configuration provides measurement parameters specifying measurements to be performed for managing a handover;
performing the measurements in accordance with the cell-change measurement configuration;
in dependence upon the measurements, sending a measurement report to the network;
receiving from the network a second message comprising at least a cell-change configuration; and
decoding the cell-change configuration, wherein the cell-change configuration provides cell parameters enabling the handover.

In some but not necessarily all examples, the measurement report identifies one or more cells and the received second message comprises a cell-change configuration for each of the identified one or more cells.

In some but not necessarily all examples, the user equipment comprises means for decoding the first message on reception and/or decoding the second message on reception.

According to various, but not necessarily all, examples there is provided a network node comprising means for:

Sending to a user equipment a first message comprising a cell-change measurement configuration, wherein the cell-change measurement configuration provides measurement parameters specifying measurements to be performed for the purpose of managing a change in a serving cell;

Receiving a measurement report based on measurements, for the purpose of managing a change in a serving cell, performed at the user equipment in accordance with the received cell-change measurement configuration;

in dependence upon the measurement report, sending to the user equipment a second message comprising at least a cell-change measurement configuration.

In some but not necessarily all examples, the measurement report identifies one or more cells and the second message comprises a cell-change configuration for each of the identified one or more cells.

In some but not necessarily all examples, the network node is configured to separate a data structure comprising:

a first information element comprising the cell-change measurement configuration; and
multiple second information elements, wherein each second information element comprises, for a candidate cell, a cell-change configuration wherein the cell-change configuration provides parameters enabling a change in serving cell to the respective candidate cell, into:
the first message, and
the second message.

According to various, but not necessarily all, examples there is provided a data structure for enabling lower layer triggered mobility (LTM) comprising:

first information element comprising a cell-change measurement configuration, wherein the cell-change measurement configuration provides parameters specifying measurements to be performed for managing a handover; and
multiple second information elements, wherein each of the multiple second information elements comprises a cell-change configuration for one of multiple cells, wherein the cell-change configuration provides parameters enabling the handover with one of the multiple cells.

In some but not necessarily all examples, the data structure comprises a third information element comprising information on what conditional handover conditions for a UE triggered change in serving cell.

In some but not necessarily all examples, the data structure comprises an information element comprising information identifying the conditions (and pointers) for decoding an identified portion of the data structure.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

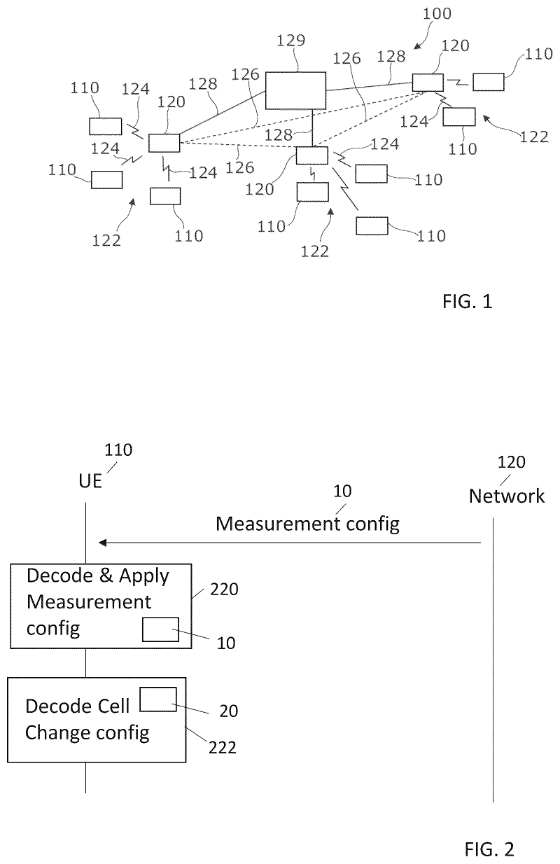

FIG. 1 shows an example of the subject matter described herein;

FIG. 2 shows another example of the subject matter described herein;

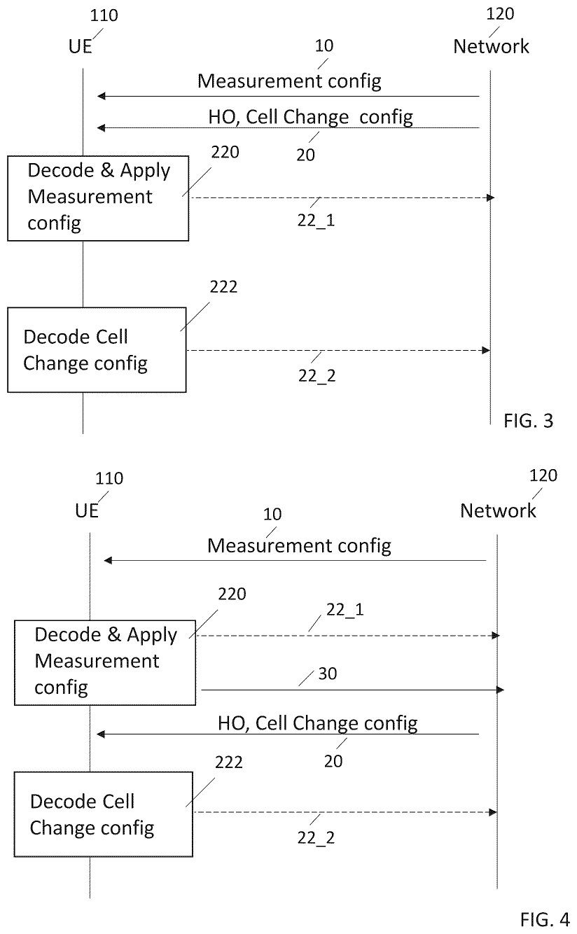

FIG. 3 shows another example of the subject matter described herein;

FIG. 4 shows another example of the subject matter described herein;

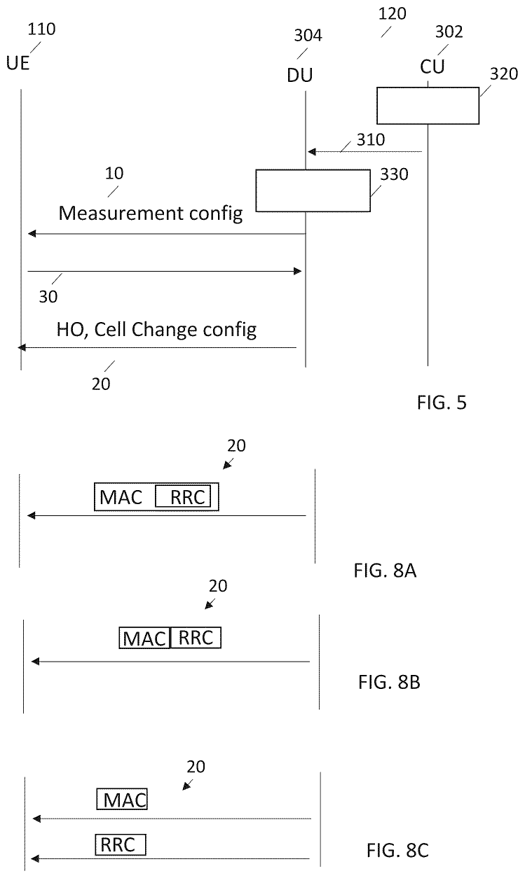

FIG. 5 shows another example of the subject matter described herein;

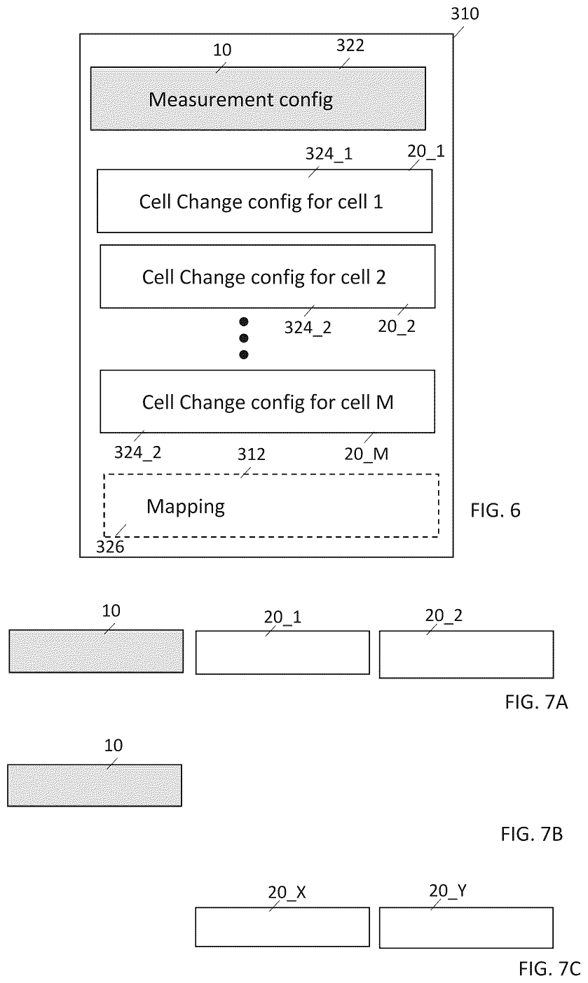

FIG. 6 shows another example of the subject matter described herein;

FIG. 7A, 7B, 7C show examples of the subject matter described herein;

FIG. 8A, 8B, 8C show examples of the subject matter described herein;

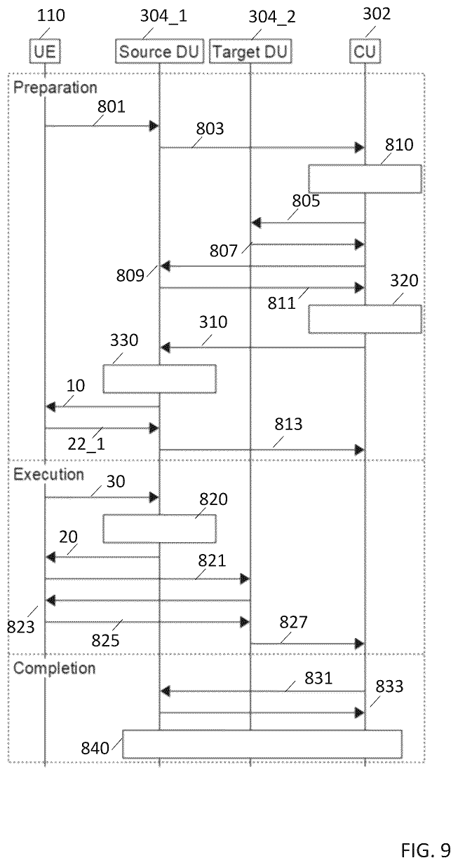

FIG. 9 shows another example of the subject matter described herein;

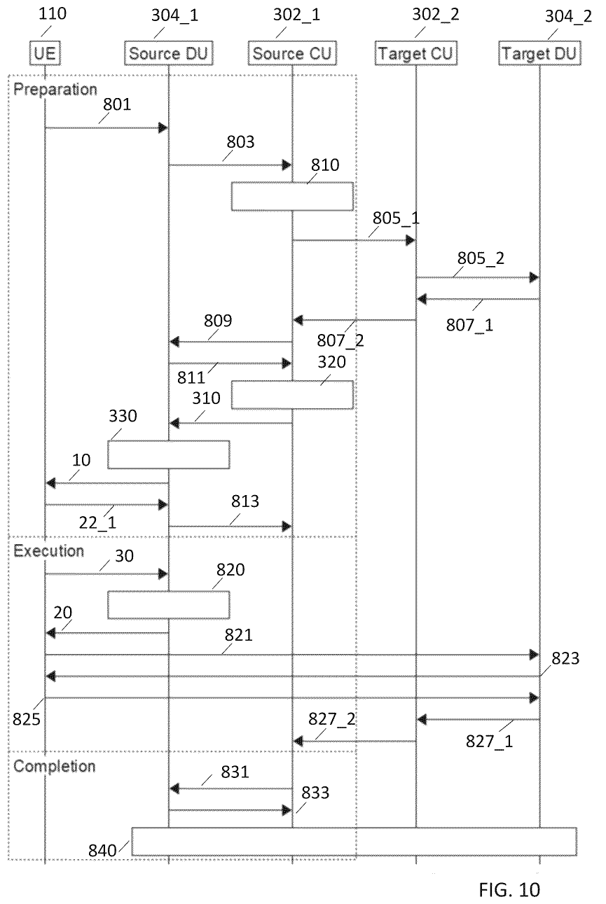

FIG. 10 shows another example of the subject matter described herein;

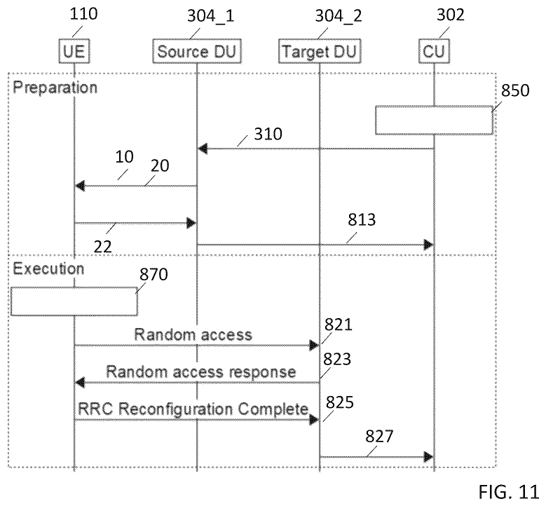

FIG. 11 shows another example of the subject matter described herein;

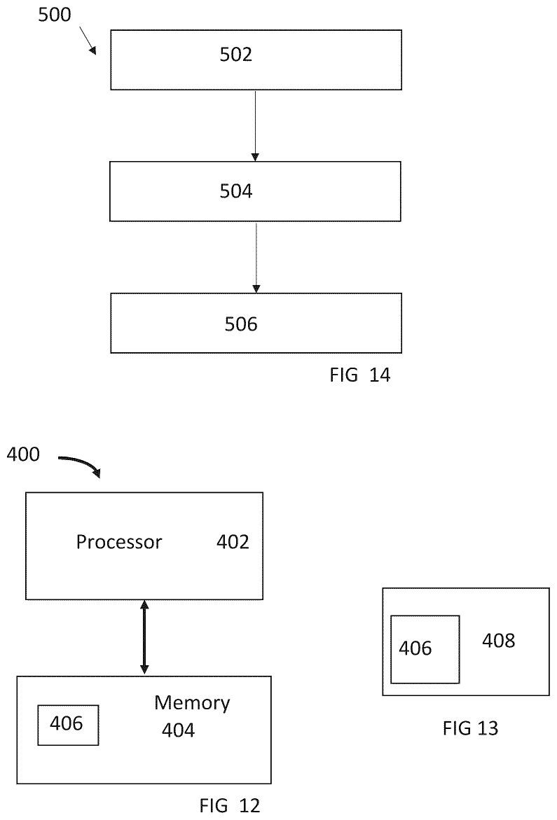

FIG. 12 shows another example of the subject matter described herein;

FIG. 14 shows another example of the subject matter described herein;

FIG. 14 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 20) and a specific instance of the class (member of the set) can be referenced using the reference number with a numerical type subscript index (e.g. 20_1) and a non-specific instance of the class (member of the set) can be referenced using the reference number with a variable type subscript index (e.g. 20_i).

### DETAILED DESCRIPTION

The following discloses examples of a user equipment 110 comprising means 220 for decoding and applying a received cell-change measurement configuration 10 before decoding 222 a received cell-change configuration 20, wherein the cell-change measurement configuration 10 provides measurement parameters specifying measurements to be performed for managing a handover, and wherein the cell-change configuration 20 provides cell parameters enabling the handover.

The following discloses in some examples a network node 120, 304 comprising: means for sending to a user-equipment 110 a cell-change measurement configuration 10 wherein the cell-change measurement configuration 10 provides measurement parameters specifying measurements to be performed for managing a handover; and means for sending, separately, to the user equipment 110 a cell-change configuration 20, wherein the cell-change configuration 20 provides cell parameters enabling the handover.

The term ‘decoding’ as applied to a ‘configuration’ means processing a data structure to obtain information. The data structure can, for example, have a defined format used to convey information. In some examples, the data structure comprises a hierarchy of information elements. The hierarchy of information elements can, for example, be defined using markup language, for example extensible markup language (XML). The data structure can, for example, have a defined format used to convey information such as Abstract Syntax Notation One (ASN.1) or similar.

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In the example illustrated the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an X2/Xn interface 126. The gNBs are also connected by means of the N2 interface 128 to the Access and Mobility management Function (AMF).

A user equipment comprises a mobile equipment. Where reference is made to user equipment that reference includes and encompasses, wherever possible, a reference to mobile equipment.

FIG. 2 illustrates an example of a user equipment 110 comprising: means 220 for decoding and applying a received cell-change measurement configuration 10 before decoding 222 a received cell-change configuration 20.

The user equipment 110 also comprises means 222 for decoding and applying a received cell-change configuration 20 after decoding and applying 222 the received cell-change measurement configuration 10.

The cell-change measurement configuration 10 provides measurement parameters specifying measurements to be performed for managing a handover. Applying the cell-change measurement configuration 10 involves making one or more measurements in accordance with the measurement parameters. The cell-change configuration 20 provides cell parameters enabling the handover.

The decoding and applying of the received cell-change configuration 10 can, for example, be dependent upon applying the decoded received cell-change measurement configuration 10.

The user equipment 110 can, for example, enable low-latency triggered mobility (LTM) that enables a serving cell change (handover) via low-latency signaling. The latency in handover once triggered can, for example, be less than 10 ms.

The user equipment 110 can, for example, enable lower layer triggered mobility (LTM). This enables a cell change via lower level signaling e.g., below layer three. The network 120 can trigger a LTM cell switch by sending a MAC control element (CE) to the UE.

The user equipment 110 also comprises means for receiving the cell-change measurement configuration 10 and the cell-change configuration 20. Instead of decoding a cell-change measurement configuration 10 and a cell-change configuration 20 at the same time, the cell-change measurement configuration 10 is decoded first and applied to enable measurements for managing handover. The separation in decoding of cell-change measurement configuration 10 and the cell-change configuration 20 allows them to be transferred separately or not.

FIG. 3 illustrates an example where the cell-change measurement configuration 10 and the cell-change configuration 20 are sent together or separately before decoding 220 the received cell-change measurement configuration 10.

The user equipment 110 is configured to receive from the network 120 a first message comprising the cell-change measurement configuration 10 and a second message comprising the cell-change configuration 20.

The user equipment 110 is configured to decode 220 the received cell-change measurement configuration 10 and then perform the measurements in accordance with the cell-change measurement configuration 10.

In some examples, the user equipment 110 is configured to selectively decode one of multiple cell-change configurations 20 in dependence on the measurement.

In some examples (not illustrated in FIG. 3), the user equipment 110 is configured to send a measurement report 30 to the network 120 in dependence upon the measurements. The measurement report 30 reporting measurements made according to the cell-change measurement configuration 10 for network triggered change of cell. In some examples, the user equipment 110 is configured to selectively decode one of multiple cell-change configurations 20 in dependence on the measurement report 30.

FIG. 4 illustrates an example where the cell-change measurement configuration 10 and the cell-change configuration 20 are sent separately.

The cell-change measurement configuration 10 is sent before decoding and applying 220 the received cell-change measurement configuration 10. The cell-change configuration 20 is sent after decoding and applying 220 of the received cell-change measurement configuration 10.

The user equipment 110 is configured to receive from the network 120 a first message comprising the cell-change measurement configuration 10 and, separately after decoding and applying 220 the cell-change measurement configuration 10, a second message comprising the cell-change configuration 20.

In FIG. 4, the user equipment 110 is configured to receive from the network 120 a first message comprising the cell-change measurement configuration 10 and to decode the received cell-change measurement configuration 10. There is no decoding of a cell-change configuration 20. The user equipment 110 is configured to perform the measurements in accordance with the cell-change measurement configuration 10 and, in dependence upon the measurements, send a measurement report 30 to the network reporting the measurements. The cell-change configuration 20 is sent in reply to measurement report 30. The user equipment 110 is configured to receive from the network 120 a second message comprising one or more cell-change configurations 20 and to decode and use at least one cell-change configuration 20.

Referring to both FIGS. 3 & 4, in some examples, the user equipment 110 is configured to decode the cell-change configuration 20 only as needed and not in advance when the cell-change measurement configuration 10 is decoded. In some examples, the user equipment 110 is configured to decode the received cell-change configuration 20 for a candidate cell, only when a change in serving cell to the candidate cell is required.

Referring to both FIGS. 3 & 4, in some examples, the user equipment 110 is configured to decode the received cell-change measurement configuration 10 and perform measurements in accordance with the received cell-change measurement configuration 10; and in dependence upon the measurements, decode a received cell-change configuration 20. In FIG. 3, the cell-change configuration 20 is already received. In FIG. 4, the cell-change configuration 20 is received in reply to the measurement report 30.

In at least some examples, the measurement report 30 is a lower layer triggered mobility (LTM) measurement report 30 for example a L1/L2 triggered mobility (LTM) measurement report 30.

In at least some examples, the measurement report 30 identifies one or more cells and the subsequent second message comprises the cell-change configuration 20 for each of the identified one or more cells.

In some examples, the user equipment 110 is configured to send a confirmation signal 22 to the network 120 that confirms that decoding 220 of the cell-change measurement configuration 10 has been completed and/or that confirms that decoding 222 of the cell-change configuration 20 has been completed. In the examples illustrated in FIGS. 3 & 4, it is optional for the user equipment 110 to be configured to send a confirmation signal 22_1 to the network 120 that confirms that decoding 220 of the cell-change measurement configuration 10 has been completed and/or it is optional for the user equipment 110 to be configured to send a confirmation signal 22_2 to the network 120 that confirms that decoding 222 of the cell-change configuration 20 has been completed.

In some examples, the one or more cell-change configurations 20 are sent in reply to receiving the confirmation signal 22_1 that confirms that decoding of the cell-change measurement configuration 10 has been completed. It will be appreciated that the measurement report 30 can replace the confirmation signal 22_1. The measurement report 30, by supplying a measurement, confirms that decoding of the cell-change measurement configuration 10 has been decoded and applied.

FIG. 5 illustrates an example of a network node 120 configured to send the cell-change measurement configuration 10 and the one or more cell-change configurations 20 to the user equipment 110.

The network node 120 is configured to send to a user-equipment 110 a cell-change measurement configuration 10 and to send, separately, to the user equipment 110 a cell-change configuration 20.

The cell-change measurement configuration 10 provides measurement parameters specifying measurements to be performed for managing a handover. The cell-change configuration 20 provides cell parameters enabling the handover.

In the example illustrated the network node 120 is configured to send a first message comprising the cell-change measurement configuration 10 and, separately, a second message comprising the cell-change configuration 20.

The network node 120 is configured to, in response to receiving from the user equipment 110 a measurement report 30 for managing handover that identifies a cell, selectively send to the user equipment 110 a cell-change configuration 20 for enabling cell change to the identified cell.

The network node 120 is configured to, in response to receiving from the user equipment 110 a measurement report 30 for managing handover that identifies a sub-set of cells, selectively send to the user equipment 110 a cell-change configuration 20 for enabling cell change to each of the identified sub-set of cells.

As illustrated in FIG. 5, in some examples, the received cell-change measurement configuration 10 and the received cell-change measurement configurations 20 originate from a message 310.

The message 310 comprises the cell-change measurement configuration 10 and multiple cell-change configurations (a cell-change configuration 20 for each one of multiple cells). The message 310 can for example be a layer three message such as a radio resource control (RRC) message.

In the example illustrated, the network node 120 is configured to send the received cell-change measurement configuration 10, but not a received cell-change configuration 20 to the user equipment 110; and is configured to, in response to receiving from the user equipment 110 a measurement report 30 for managing handover that identifies a sub-set of the multiple cells, selectively send to the user equipment 110 cell-change configurations 20 for enabling cell change to each of the identified sub-set of cells.

In the example illustrated, but not necessarily all examples, the network node 120 has a disaggregated (split) architecture. The network node 120 comprises one or more distributed units (DU) 304, and a centralized unit, CU 302.

The CU 302 is a logical node configured to host a Radio Resource Connection, RRC, layer and/or other higher layers of the network node 120. The CU 302 controls the operation of one or more DUs 304. The DU 304 is a logical node configured to host the lower layers (the Radio Link Control, RLC, protocol layer, Medium Access Control, MAC, layer and Physical, PHY, layer) of the network node 120. The DU 304 may communicate via a dedicated interface (e.g., an F1 interface) to a RRC layer hosted by the CU 302. One DU 304 may support one or multiple cells 122. The DU 304, may host one or more Transmission Reception Points, TRPs.

The DU 304 sends the cell-change measurement configuration 10 to the UE 110, receives the measurement report 30 from the UE 110, and sends the cell-change configuration 20 to the UE 110. The CU 302 sends the message 310 to the DU 304.

In more detail, the CU 302 obtains 320 the cell-change measurement configuration 10 and a cell-change configuration 20 for each target cell and sends them to the DU 304 via the message 310. The cell-change measurement configuration 10 provides information needed for the UE 110 to monitor the candidate target cells. As an example, this may be measurement reporting configuration for LTM. The cell-change configuration 20 provides information that the UE 110 needs to execute a handover and connect to the prepared target cells.

At block 330, the source DU 304_1 (which will trigger handover) stores the cell-change configurations 20 for the target cells. The source DU 304_1 forwards to the UE 110 the cell-change measurement configuration 10. The UE 110 decodes the received cell-change measurement configuration 10 containing necessary information on the cells that should be monitored and performs monitoring and reporting.

The lower layer (L1/L2) triggered mobility is a lower layer procedure i.e., below layer 3 and is performed by the DU 304. The triggering of this procedure is performed by the DU. The setup is performed by the CU. The medium access control (MAC) entity is in the DU 304. The radio resource control (RRC) entity is in the CU 302. The LTM MAC control element (CE) sent from the DU 304 to the UE 110 and used to trigger handover can also be used to transfer or assist transfer of the cell-change configuration 20 used at handover.

An example of the message 310 is illustrated in FIG. 6. The message 310 is a data structure comprising: a first information element 322 comprising the cell-change measurement configuration 10 wherein the cell-change measurement configuration 10 provides parameters specifying the measurements to be performed for managing the handover; and multiple second information elements 324, wherein each of the multiple second information elements 324 comprise the cell-change configuration 20 for one of multiple candidate cells, and wherein the cell-change configuration 20 provides parameters enabling the handover with one of the multiple candidate cells.

The second information element 324_1 comprises the cell-change configuration 20_1 for a first candidate cell of the multiple candidate cells. The cell-change configuration 20_1 provides parameters enabling handover to the first candidate cell.

The second information element 324_2 comprises the cell-change configuration 20_2 for a second candidate cell of the multiple candidate cells. The cell-change configuration 20_2 provides parameters enabling handover to the second candidate cell.

The second information element 324_M comprises the cell-change configuration 20_M for a M^{th} candidate cell of the multiple candidate cells. The cell-change configuration 20_M provides parameters enabling handover to the M^{th} candidate cell.

In some examples, for example as illustrated in FIG. 6, the message 310 comprises a third information element 326. The third information element 326 identifies the conditions for causing decoding of an identified portion of the data structure 310 at the UE 110. In at least some examples, the third information element 326 comprises mapping information 312. The mapping information 312 comprises one-to-one mappings for each cell-change measurement configuration 10, that map the cell-change configuration 20 to a cell identifier.

Referring to FIG. 5, the network node 120 is configured to, in response to receiving from the user equipment 110 a measurement report 30 for managing handover that identifies a sub-set of the multiple cells using multiple cell identifiers, selectively sending to the user equipment 110 cell-change configurations 20 for enabling cell change to each of the identified sub-set of cells.

The network node 120 uses the mapping information 312 to map the received cell identifiers to the corresponding cell-change configurations 20 of the message 310. The network node 120 sends the corresponding cell-change configurations 20 to the UE 110.

The mapping information 312 obviates the need to decode the cell-change configurations 20 in order to identify the cell to which they correspond. This information is provided in the clear in the mapping information.

In at least some examples the message 310 is a radio resource control (RRC) message.

In the example illustrated, the message 310 is a splitable message. It can be stored as separate information elements. It can be transferred at different times to the UE 110 as separate information elements.

The DU 304 is configured to separate the message 310 into a first message comprising a first information element 322 comprising the cell-change measurement configuration 10; and into a second message comprising multiple second information elements 324, wherein each second information element 324 comprises, for a candidate cell, a cell-change configuration 20. A cell-change configuration 20 provides parameters enabling a change in serving cell to the respective candidate cell.

LTM is a procedure in which a network node 120 receives measurement reports 30 from UEs, and on their basis, the network node 120 controls a change in UEs' serving cell(s) through a MAC CE. The network node 120 prepares one or multiple candidate cells and provides the cell-change configuration 20 for the prepared candidate cells to the UE. Then LTM cell switch is triggered, by selecting one of the cell-change configuration 20 as target configuration for LTM. The trigger for selection can be at the network node (normal handover) or can be at the user equipment (conditional handover). The cell-change configuration 20 can, for example, define information for use in a Random Access procedure for connecting to a new cell. A cell-change configuration 20 can be provided as a delta configuration (that is change relative to a reference configuration) or as a full explicit cell-change configuration 20.

FIG. 7A illustrates an example in which the cell-change measurement configuration 10 and one or more cell-change configurations 20_1, 20_2 are sent together to the user equipment 110 from the network node 120. The user equipment 110 is configured to receive from the network node 120 the message comprising the cell-change measurement configuration 10 and at least one cell-change measurement configuration 10.

In some examples, the cell-change measurement configuration 10 and multiple cell-change configurations 20 and are sent together to the user equipment 110, for example, in a single message to enable a UE triggered change of cell (conditional handover). The message can, for example, be a layer-3 radio Resource Control (RRC) message.

In some examples, the user equipment 110 is configured to use the measurements made according to the cell-change measurement configuration 10 for a UE triggered change of cell. In at least some examples, the user equipment is configured to determine to initiate a handover with a target candidate cell, decode the received cell-change configuration 20 for the target candidate cell based on the determination.

FIGS. 7A and 7B illustrate an example in which the cell-change measurement configuration 10 and one or more cell-change configurations 20_1, 20_2 are sent separately to the user equipment 110 from the network node 120.

FIG. 7A illustrates that, in the example illustrated, the cell-change measurement configuration 10 is sent from the network node 120 (the DU 304) to the UE 110 without a cell-change configuration 20 in a first message. FIG. 7B illustrates that, one or more cell-change configurations 20 are sent from the network node 120 (the DU 304) to the UE 110 without a cell-change measurement configuration 10 in a second message. The network node 120 (DU 304) is configured to, in response to receiving from the user equipment 110 a measurement report 30 for managing handover that identifies a sub-set of cells 122_X, 122_Y, selectively send to the user equipment a cell-change configuration 20_X, 20_Y for enabling cell change to each of the identified sub-set of cells. In the example illustrated the second message comprises a cell-change configuration 20_X, for enabling cell change to one of the identified sub-set of cells and comprises a cell-change configuration 20_Y, for enabling cell change to another one of the identified sub-set of cells.

In at least some examples, the user equipment 110 is configured to decode the first message on reception and/or decode the second message on reception.

FIGS. 8A, 8B, 8C illustrate examples of sending the cell-change configurations 20 from the network node 120 (DU 304) to the UE 110.

In FIG. 8A, the cell-change configurations 20 is sent from the network node 120 (DU 304) to the UE 110 within a second message that is a LTM medium access control (MAC) message. The cell-change configurations 20 is radio resource control (RBB) information, received at the network node 120 as part of a RRC message. The cell-change configurations 20 is comprised within an information element within the MAC message.

In FIG. 8B, the cell-change configurations 20 is sent from the network node 120 (DU 3CU04) to the UE 110 by being appended to a medium access control (MAC) message.

The cell-change configurations 20 is radio resource control (RRC) information, received at the network node 120 as part of a RRC message. The cell-change configurations 20 is appended as an RRC message to a MAC message.

In FIG. 8C, the cell-change configurations 20 is sent separately to the LTM medium access control (MAC) message. The cell-change configurations 20 is radio resource control (RBB) information, received at the network node 120 as part of a RRC message. The cell-change configurations 20 is sent as an RRC message.

The message that is generated by the DU is a LTM MAC-level message. The DU also transfers (in the MAC message, appended to the MAC message or separately to the MAC message) the relevant RRC segment that was obtained earlier by the CU 302 and stored in the DU 304, which is a Layer 3 message.

A composite message (FIG. 8A, 8B) comprises the MAC-level message (L2) that was generated by the DU 304, and the RRC-segment that was given to the DU 304 by the CU 302. The DU 304 forwards both these messages together at cell switch. To identify which layer three segment to forward (since the DU 304 does not have the ability to decode these messages), then the DU 304 uses the mapping. If the DU 304 wants UE 110 to switch to cell 1, it sends to the UE 110 the MAC-level message containing instructions for the UE 110 to switch to cell 1, as well as the RRC-level message which contains information on how the UE can switch to cell 1. It is up to the UE 110 to be able to decode these RRC messages separately from one-another.

In one implementation (FIG. 8A) the RRC-level message is contained within the LTM MAC CE. In another implementation (FIG. 8B) the RRC-level message is appended to the LTM MAC CE. In another implementation (FIG. 8C), the RRC segment could be sent subsequently to the LTM MAC CE. The UE 110 knows that after receiving a MAC level command triggering the cell switch, it should expect an RRC segment instructing how to connect to the target cell.

The term handover is used to refer to a change in serving cell, this includes changes in serving cell associated with dual connectivity (DC).

A number of different example implementations will now be provided in the context of 3GPP New Radio. In these examples, the same references will be used as in previous examples.

In these examples, the UE110 decodes the content of the RRC Reconfiguration message 310 in parts, i.e., UE may decode one part of the message (e.g., the cell-change measurement configuration 10) at a different time than another part (e.g., the cell-change configurations 20). Optionally, this could also involve each part 10, 20 being received independently. Optionally, the UE 100 indicates 22 the success of the decoding 220, 222 of each part independently to the network 120.

The cell-change measurement configuration 10 provides measurement parameters specifying measurements to be performed for managing a handover.

The cell-change configuration 20 provides cell parameters enabling the handover.

The partial decoding of RRC message 310 at the UE 110 requires that the structure of the RRC message 310 that is sent to the UE when LTM is configured is split into two or more parts, e.g., common, and cell-specific parts. Generally, when splitting the RRC message 310 into multiple parts, each part is forwarded to the UE 110 only when it is needed. The UE 110 can thus be informed when a specific part of the message is to be decoded by receipt of that part. Optionally, the network 120 can also indicate to the UE 110 whether a response on the decoding success is needed. For example, the message could have a part (a cell-change configuration 20) that is only used when UE 110 does handover to a specific serving cell (e.g., via the LTM procedure).

Additionally, the message structure could be such that it can be referred to via lower layer triggering: For example, a MAC CE (or DCI) could indicate applicability to a specific message segment (specific cell-change configuration 20), which the UE 110 then decodes and uses in the subsequent procedures for connecting to the target cell.

The RRC message 310 comprises different segments including the cell-change measurement configuration 10 and a cell-change configuration 20 for each one of multiple cells e.g. as illustrated in FIGS. 6 and 7A.

A RRC segment can be self-decodable. Alternatively a segment can be dependent-decodable, that is, it can only be decoded when combined with another higher-order segment. The segment can be represented as a ‘delta’ compared to the higher-order segment. There can in general be multiple different segments that are either independent or dependent of each other. In terms of Abstract Syntax Notation One (ASN.1), the decoding can be done independently if each part is separated into containers (for example using OCTET STRING) that are decoded independently. The ASN.1 syntax may also indicate the contents of the containers to allow for faster decoding.

In the example below the RRC message 310, RRCPartialReconfiguration, includes 1 . . . maxRRC-Segments RRC segments wrapped in a segment container (i.e. OCTET STRING), and each RRC-Segment then contains an RRCReconfiguration-message:

RRCPartialReconfiguration ::= SEQUENCE {
rrc-Segments SEQUENCE (SIZE (1..maxRRC-Segments)) OF RRC-
SegmentContainer-r18,
lateNonCriticalExtension OCTET STRING OPTIONAL,
nonCriticalExtension SEQUENCE { } OPTIONAL
}
RRC-SegmentContainer-r18 ::= SEQUENCE {
segment OCTET STRING (CONTAINING RRC-Segment-r18),
decodingRequested BOOLEAN
}
RRC-Segment-r18 ::= SEQUENCE {

| | |
|---|---|
| rrcReconfiguration-r18 | RRCReconfiguration, |

lateNonCriticalExtension OCTET STRING OPTIONAL,
nonCriticalExtension SEQUENCE { } OPTIONAL
}

The approach does not transmit the entire RRC Configuration message to the UE 110 when LTM is setup, the CU 402 forwards to the UE 110 only the information that is needed to monitor the cells configured with LTM (the cell-change measurement configuration 10). The information needed to connect to the other cells (the cell-change configurations 20) can be forwarded to the serving DU 404 for later transmission (e.g., selective transmission of some but not all of the cell-change configurations 20) to the UE 110 when needed.

The UE 110 needs to decode the first RRC segment (the cell-change measurement configuration 10) provided by the CU 402 because it needs to have information on the cells to monitor and also the details that need to be reported to the serving DU 402.

Then, in some examples, the UE 110 can send measurement reports 30 to the serving DU 402. Upon making a decision to trigger cell switch, the serving DU 402 can send a MAC CE command to the UE 110 to switch cell, and also append the RRC segment (the cell-change configuration 20) that contains the information needed to connect to the target cell. The UE 110 decodes this message and uses the content to connect to the target cell.

These examples enable the possibility of decoding the RRC Reconfiguration message for LTM in parts only when needed. Moreover, this also has the benefit that the signalling gets reduced, and the UE 110 decodes smaller messages. This RRC splitting procedure is applicable to both the inter-CU case and intra-CU case. It is also applicable to network triggered handover and UE-triggered conditional handover.

For the intra-CU case, an example signalling diagram is presented in FIG. 9.

The signalling diagram illustrates a preparation phase, an execution phase, and a completion phase. The preparation phase prepares a UE 110 to make measurements and send measurement reports 30 according to a RRC cell-change measurement configuration 10. During the execution phase, the UE 110 makes measurements and sends measurement reports 30 according to a received RRC cell-change measurement configuration 10. This triggers a transfer of a RRC cell-change configuration 20 (for a cell) from the network 120 to the UE 110. During the execution phase, the UE 110 uses the received RRC cell-change configuration 20 to perform a handover to the cell in accordance with the received RRC cell-change configuration 20.

The RRC cell-change measurement configuration 10 is received and decoded during the preparation phase, and is used during the execution phase.

The RRC cell-change configuration 20 is received and decoded during the execution phase and is used during the completion phase.

The source DU 304_1 and the target DU 304_2 are controlled by the CU 302.

The UE 110 forwards 801, 803 an L3 measurement report containing measurement information of the serving and target cell(s). The L3 measurement report is sent 801 from the UE 110 to the source DU 304_1 and transferred 803 from the source DU 304_1 to the CU 302, for example, using UL RRC message transfer. A L3 measurement report can be sent from the UE 110 to the target DU 304_2 and from the target DU 304_2 to the CU 302 (not illustrated).

At block 810, the CU 302 make a handover decision and identifies candidate target cells.

The network requests the preparation of the candidate cells controlled by the DUs (in this example it is the target DU 304_2, however the scheme is applicable to broader scenarios), by sending the UE Context Setup Request Message 805. The target DU 304_2 provides the configuration of the UE (a cell-change configuration 20) in the UE context Setup Response Message 807. This may or may not contain UE-specific information.

The CU requests the preparation of a candidate cell controlled by the source DU 304_1 by sending UE Context Modification Request message 809. The source DU 304_1 provides 811 the configuration of the UE in the Context Modification Response message to the CU 302. The configuration may contain UE-specific and non-UE-specific parts.

After having received all the necessary information from the candidate target cells, the CU 302 prepares the source DU 304_1 to trigger handover. The CU 302 generates 320 the RRC Reconfiguration message segments (the cell-change measurement configuration 10 and a cell-change configuration 20 for each target cell). The cell-change measurement configuration 10 provides information needed for the UE to monitor the candidate target cells. As an example, this may be a measurement reporting configuration for LTM. The cell-change configuration 20 provides information that the UE 110 needs to execute a handover and connect to the prepared target cells upon the reception of the LTM MAC CE command to change the serving cell. The RRC Reconfiguration segments (the cell-change measurement configuration 10 and a cell-change configuration 20 for each target cell) are then forwarded to the source DU 304_1 from the CU 302.

At block 330, the source DU 304_1 (which will trigger handover) stores the RRC Reconfiguration segments which contain information on how to connect to each of the target cells (the cell-change configurations 20 for the target cells).

The source DU 304_1 forwards to the UE 110 the RRC segment containing information on the target cells that need to be monitored (the cell-change measurement configuration 10).

The UE 110 confirms 22_1 the reception of the RRC Reconfiguration segment to the source DU 304_1 which sends a confirmation 813 to the CU 302 (e.g., UL RRC message transfer).

The UE 110 perform RRC Reconfiguration (with partial decoding) using the received cell-change measurement configuration 10 containing necessary information on the cells that should be monitored. The UE 110 decodes the cell-change measurement configuration 10 and applies it to make measurements e.g., L1 beam measurements.

The UE 110 starts to report 30 the L1 beam measurements of the serving and candidate target cells.

Upon determining that there is a candidate cell having a better radio condition than the serving cell, the source DU 304_1 can forward the segment of RRC Reconfiguration message containing only the information about the target cell that the UE should attempt random access towards. The source DU 304_1 forwards the cell-change configuration 20 for the target cell. Not all of the stored cell-change configurations 20 are forwarded; only the cell-change configuration(s) 20 required are forwarded. The forwarding is selective. This saves for the UE 110 the computational effort of having to decode all the cell-change configurations 20 including cell-change configurations 20 containing information on the candidate cells to which the UE does not connect to.

At block 820, the source DU 804_1 decides to trigger a cell handover (a serving cell change).

The source DU 804_1 sends a MAC CE to the UE to trigger a cell change and sends the RRC segment needed to connect to target cell (the cell-change configurations 20 for the target cell).

Handover from the serving cell to target cell is executed. The UE 110 sends a Random Access Request 821, receives a Random Access Response 823, and then sends a RRC Reconfiguration Complete message 825 to the target DU 304_2 which informs 827 the CU 802 (e.g. using UL RRC message transfer);

The UE context is released from the source DU. Path switch is performed to the new serving DU. The CU 802 sends 831 a context release command to the old source DU 304_1. The old source DU 304_1 replies with a target UE context release complete message 833. At block 840 the path switch is completed.

For the intra-CU case, an example signalling diagram is presented in FIG. 10. It is similar to FIG. 9. However, instead of the source DU 304_1 and the target DU 304_2 being controlled by the CU 302 the source DU 304_1 is controlled by the source CU 302_1 and the target DU 304_2 is controlled by the target CU 302_2. There is therefore extra signaling 805, 827 between the source CU 302_1 and the target CU 32_2. Otherwise the signaling is similar.

The source CU decides to configure LTM for one (or more) DUs which operate under the coverage of another CU and the RRC splitting for the LTM procedure is enabled for the inter-CU case.

The network 120 requests the preparation of the candidate cells controlled by the DUs (in this example it is the target DU 304_2, however the scheme is applicable to broader scenarios), by sending the UE Context Setup Request Message 805. The target DU 304_2 is controlled by the target CU 302_2 so the UE Context Setup Request Message 805 is sent in two legs first a Request LTM configuration with partial decoding message is sent 805_1 from the source CU 304_1 to the target CU 302_2 and then a UE context setup request message is sent 805_2 to the target DU 304_2 from the target CU 302_2.

The target DU 304_2 provides the configuration for the UE (a cell-change configuration 20) in the UE context Setup Response Message 807 sent to the source CU 302_1. This may or may not contain UE-specific information. The target DU 304_2 Is controlled by the target CU 302_2 so the UE context Setup Response Message 807 is sent in two legs first a UE context setup response message is sent 807_1 from the target DU 304_2 to the target CU 302_2 and then a LTM configuration with partial decoding response message is sent 807_2 from the target CU 302_2 to the source CU 302_1.

When handover from the serving cell to target cell is executed, the UE 110 sends a Random Access Request 821, receives a Random Access Response 823, and then sends a RRC Reconfiguration Complete message 825 to the target DU 304_2. The target DU 304_2 informs 827 the source CU 802_1. The target DU 304_2 is controlled by the target CU 302_2 so this is achieved in two legs. First it sends 827_1 a LTM complete (with partial decoding) message from the target DU 304_2 to the target CU 302_2 and then a LTM complete (with partial decoding) message is sent 827_2 from the target CU 302_2 to the source CU 302_1.

FIG. 11 illustrates an example where the UE 110 triggers the switch (handover) to the target cell based on conditions provided by the CU. This is a form of conditional handover. FIG. 11 has similarities to the FIG. 9 and FIG. 10 and similar references are used. In comparison to FIG. 9, instead of the CU 302 preparing 320, 310 the source DU 304_1 to trigger handover, the CU 302 prepares 850, 310, 10, 20 the UE 110 to trigger 870 handover. The source DU 304_1 and the target DU 304_2 are controlled by the CU 302 as in FIG. 9. However, the arrangement of FIG. 10 is also possible.

The signalling diagram illustrates a preparation phase and an execution phase. The preparation phase prepares the UE 110 to make measurements according to a RRC cell-change measurement configuration 10 and to trigger handover according to a RRC cell-change configuration 20. As the UE 110 triggers handover it does not need to send measurement reports to the network 120 to enable the network to trigger handover.

During the execution phase, the UE 110 makes measurements and triggers handover. During the execution phase, the UE 110 uses the previously received RRC cell-change configuration 20 to perform a handover to the target cell in accordance with the RRC cell-change configuration 20.

The RRC cell-change measurement configuration 10 is received and decoded during the preparation phase, and is used during the execution phase.

The RRC cell-change configuration 20 is received during the preparation phase and is decoded and used during the execution phase.

The source DU 304_1 and the target DU 304_2 are controlled by the CU 302.

At block 850, the CU 302 makes a conditional handover decision and identifies candidate target cells. The CU 302 prepares the UE 110 to trigger handover.

The CU 302 generates 850 the RRC Reconfiguration message segments (the cell-change measurement configuration 10 and a cell-change configuration 20 for each target cell). The cell-change measurement configuration 10 provides information needed for the UE 110 to monitor the candidate target cells. As an example, this may be measurement reporting configuration for LTM. The cell-change configuration 20 provides information that the UE 110 needs to execute a handover and connect to the prepared target cells when it triggers handover. The RRC Reconfiguration segments (the cell-change measurement configuration 10 and a cell-change configuration 20 for each target cell) are then forwarded 310 to the source DU 304_1 from the CU 302, which forwards the cell-change measurement configuration 10 and a cell-change configuration 20 for each target cell to the UE 110.

The UE 110 (which will trigger handover) stores the RRC Reconfiguration segments which contain information on how to connect to each of the target cells (the cell-change configurations 20 for the target cells).

The UE 110 confirms 22 the reception of the RRC Reconfiguration segments to the source DU 304_1 which sends a confirmation 813 to the CU 302 (e.g., UL RRC message transfer).

The UE 110 perform RRC Reconfiguration (with partial decoding) using the received cell-change measurement configuration 10 containing necessary information on the cells that should be monitored. The UE 110 decodes the cell-change measurement configuration 10 and uses the decoded the cell-change measurement configuration 10 for measurements and monitoring. The cell-change measurement configuration 10 can comprise the conditions that are satisfied for UE-triggered handover.

Upon determining satisfaction of a handover condition for a particular cell(s), the UE 110 decodes 870 only the cell-change configuration(s) 20 for the conditionally selected cell(s). The UE 110 decodes only the cell-change configuration(s) 20 that are required. The cell-change configuration(s) 20 that are not required because they do not relate to the conditionally selected cell(s) are not decoded. This saves the UE 110 the computational effort of having to decode all the cell-change configurations 20 including cell-change configurations 20 containing information on the candidate cells to which the UE does not connect to.

In some examples, the UE 110 decodes the part of the RRC message that contains information on how to connect to the target cells, which can be indicated by the decodingRequested flag presented earlier. Then, the UE 110 begins to measure the candidate cells, and, when the condition is triggered (e.g., L1 RSRP of target cell>L1 RSRP of source cell), the UE decodes the portion of the RRC message that contains information on how to connect to the target cell.

Handover from the serving cell to target cell is executed. The UE 110 sends a Random Access Request 821, receives a Random Access Response 823, and then sends a RRC Reconfiguration Complete message 825 to the target DU 304_2 which informs 827 the CU 802 (e.g. using UL RRC message transfer);

Although not illustrated in this FIG, the UE context is released from the source DU and path switch is performed to the new serving DU.

In any of the preceding examples, assistance can be provided to a layer 2 entity (e.g., the UE 110 performing LTM or the DU supporting LTM) to enable the selective decoding of a sub-set of the cell-change configurations 20.

In the case when the network (e.g. DU 304) selectively forwards to the UE 110 a cell-change configuration 20, the DU 304 needs to be informed by the CU 302 which part of the RRC Reconfiguration message is to be to forward to the UE 110. This obviates the need for the DU 304 to decode the entire RRC Reconfiguration message. This informing can be via a UE context modification message.

As an example, let the RRC message constructed by the CU be split into 3 parts (as shown in FIG. 7A). Then, a mapping is provided by the CU 302 to the DU 304 (as an example, it could be a dictionary) that would map cell identifiers to specific parts of the RRC Reconfiguration message (the appropriate cell-change configuration 20). A specific part of the identifies RRC Reconfiguration message can be identified using pointers e.g., starting and stopping points of the segment. At cell switch, if the DU 304 decides to re-route the UE to cell X, it needs to send the MAC CE command with the segment associated with cell X.

In case the UE 110 is required to do the selective decoding, the approach would be similar, except that now the mapping would be given directly (from the CU) to the UE (e.g., in the RRC Reconfiguration message). Then, when handover is triggered (by DU or UE), the UE would decode the relevant part.

FIG. 14 illustrates an example of a method 500. The method 500 can for example be performed at a user equipment 110.

The method 500 comprises, at block 502, receiving a cell-change measurement configuration 10.

The method 500 comprises, at block 504, decoding and applying a received cell-change measurement configuration before decoding a received cell-change configuration. The cell-change measurement configuration provides measurement parameters specifying measurements to be performed for managing a handover, and the cell-change configuration provides cell parameters enabling the handover.

The method 500 comprises, at block 506, decoding and applying a received cell-change configuration.

The cell-change configuration 20 can, for example, be received after block 504. The cell-change configuration 20 can, for example, be received before block 504.

FIG. 12 illustrates an example of a controller 400 suitable for use in an apparatus 110, 120, 302, 304. Implementation of a controller 400 may be as controller circuitry. The controller 400 may be implemented in hardware alone, have certain aspects in software including firmware alone or can be a combination of hardware and software (including firmware).

As illustrated in FIG. 12 the controller 400 may be implemented using instructions that enable hardware functionality, for example, by using executable instructions of a computer program 406 in a general-purpose or special-purpose processor 402 that may be stored on a computer readable storage medium (disk, memory etc.) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus when loaded into the processor 402. The computer program instructions, of the computer program 406, provide the logic and routines that enables the apparatus to perform the methods illustrated in the accompanying FIGs. The processor 402 by reading the memory 404 is able to load and execute the computer program 406.

The apparatus comprises: at least one processor 402; and at least one memory 404 including computer program code the at least one memory 404 and the computer program code configured to, with the at least one processor 402, cause the apparatus at least to perform the functions described above.

In some examples, the user equipment 110 comprises:

at least one processor 402; and
at least one memory 404 including computer program code,
the at least one memory 404 storing instructions that, when executed by the at least one processor 402, cause the apparatus at least to:
   decoding and applying a received cell-change measurement configuration before decoding a received cell-change configuration,
   wherein the cell-change measurement configuration provides measurement parameters specifying
   measurements to be performed for managing a handover, and
   wherein the cell-change configuration provides cell parameters enabling the handover.

As illustrated in FIG. 13, the computer program 406 may arrive at the apparatus via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus may propagate or transmit the computer program 406 as a computer data signal.

In at least some example, there is provided computer program instructions for causing a user equipment 110 to perform at least the following or for performing at least the following:

decoding and applying a received cell-change measurement configuration before
decoding a received cell-change configuration,
wherein the cell-change measurement configuration provides measurement parameters specifying
measurements to be performed for managing a handover, and
wherein the cell-change configuration provides cell parameters enabling the handover.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying FIGs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

As used here ‘module’ refers to a unit or apparatus that excludes certain parts/components that would be added by an end manufacturer or a user. The user equipment 110 can be a module, for example.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. A user equipment comprising:
at least one processor; and
at least one memory including computer program code, the at least one memory and the computer program code configured to, with the at least one processor, cause the user equipment at least to perform
decoding and applying a received cell-change measurement configuration before decoding a received cell-change configuration,
wherein the cell-change measurement configuration provides measurement parameters specifying measurements to be performed for managing a handover, and wherein the cell-change configuration provides cell parameters enabling the handover.

2. The user equipment as claimed in claim 1 caused to at least perform:
decoding the received cell-change measurement configuration;
performing the measurements in accordance with the received cell-change measurement configuration; and
in dependence upon the measurements, decoding the received cell-change configuration.

3. The user equipment as claimed in claim 1 caused to at least perform:
determining to initiate the handover with a candidate cell;
decoding the received cell-change configuration for the candidate cell based on the determination.

4. The user equipment as claimed in claim 1 caused to at least perform transmitting to the network a lower layer triggered mobility (LTM) measurement report in dependence upon the performed measurements.

5. The user equipment as claimed in claim 1 caused to at least perform:
confirming to the network a decoding of the received cell-change measurement configuration and/or confirming to the network a decoding of the received cell-change configuration.

6. The user equipment as claimed in claim 1 caused to at least perform:
receiving from a network a first message comprising the cell-change measurement configuration and a second message comprising the cell-change configuration.

7. The user equipment as claimed in claim 6 caused to at least perform decoding the received cell-change measurement configuration;
performing the measurements in accordance with the cell-change measurement configuration;
receiving the second message comprising the cell-change handover configuration; and
decoding the received cell-change configuration.

8. The user equipment as claimed in claim 6, wherein the second message comprises the cell-change configuration for one or more cells for which user equipment has performed measurements.

9. The user equipment as claimed in claim 7 caused to at least perform decoding the first message on reception and/or decoding the second message on reception.

10. The user equipment as claimed in claim 1 caused to at least perform receiving from a network a message comprising the cell-change measurement configuration and the cell-change configuration.

11. The user equipment as claimed in claim 10, wherein the message comprises layer-3 radio Resource Control (RRC) information.

12. The user equipment as claimed in claim 10 caused to at least perform using the measurements made according to the cell-change measurement configuration for a UE triggered change of cell.

13. The user equipment as claimed in claim 10, wherein the message comprises:
a data structure comprising:
a first information element comprising the cell-change measurement configuration wherein the cell-change measurement configuration provides parameters specifying the measurements to be performed for managing the handover; and
multiple second information elements, wherein each of the multiple second information elements comprises the cell-change configuration for one of multiple candidate cells, and wherein the cell-change configuration provides parameters enabling the handover with one of the multiple candidate cells.

14. A method comprising:
decoding and applying a received cell-change measurement configuration before decoding a received cell-change configuration,
wherein the cell-change measurement configuration provides measurement parameters specifying
measurements to be performed for managing a handover, and
wherein the cell-change configuration provides cell parameters enabling the handover.

15. A network node comprising:
at least one processor; and
at least one memory including computer program code, the at least one memory and the computer program code configured to, with the at least one processor, cause the network node at least to perform
sending to a user-equipment a cell-change measurement configuration wherein the cell-change measurement configuration provides measurement parameters specifying measurements to be performed for managing a handover;
sending, separately, to the user equipment a cell-change configuration, wherein the cell-change configuration provides cell parameters enabling the handover.

16. The network node as claimed in claim 15, configured to send a first message comprising the cell-change measurement configuration and, separately, a second message comprising the cell-change configuration.

17. The network node as claimed in claim 15, configured to, in response to receiving from the user equipment a measurement report for managing handover that identifies a cell, selectively sending to the user equipment a cell-change configuration for enabling cell change to the identified cell or
configured to, in response to receiving from the user equipment a measurement report for managing handover that identifies a sub-set of cells, selectively sending to the user equipment a cell-change configuration for enabling cell change to each of the identified sub-set of cells.

18. The network node as claimed in claim 15, wherein the network node is configured to receive a message comprising the cell-change measurement configuration and a cell-change configuration for multiple cells; and is configured to send the received cell-change measurement configuration, but not a received cell-change configuration to the user equipment; and is configured to selectively send to the user equipment a cell-change configuration for enabling cell change to a sub-set of cells.

19. The network node as claimed in claim 18, configured to, in response to receiving from the user equipment a measurement report for managing handover that identifies a sub-set of the multiple cells, selectively send to the user equipment a cell-change configuration for enabling cell change to each of the identified sub-set of cells.

20. The network node as claimed in claim 16, wherein the received message comprises a data structure comprising:
a first information element comprising the cell-change measurement configuration wherein the cell-change measurement configuration provides parameters specifying the measurements to be performed for managing the handover; and
multiple second information elements, wherein each of the multiple second information elements comprises the cell-change configuration for one of multiple candidate cells, and wherein the cell-change configuration provides parameters enabling the handover with one of the multiple candidate cells.
